(19) United States
(12) Patent Application Publication
(10) Pub. No.: US 2008/0301400 A1
(43) Pub. Date: Dec. 4, 2008

(54) Method and Arrangement for Efficiently Accessing Matrix Elements in a Memory

(75) Inventor: Dietmar Gassmann, Dresden (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/095,166

(22) PCT Filed: Nov. 29, 2006
(86) PCT No.: PCT/IB06/54500

§ 371 Date: May 28, 2008

(30) Foreign Application Priority Data
Dec. 1, 2005 (EP) 05111546.7

(51) Int. Cl. G06F 12/02

(52) U.S. Cl. 711/220; 711/E12.014

(57) ABSTRACT

The invention relates to a method for accessing matrix elements, wherein accesses to two matrix elements that are adjacent in a row or in a column of a matrix and that are each specified by a respective relative address (aᵣ, a_{c}) are performed for the first of said elements in a first memory block (Bₚ₁) using a first local address (a′₁) and for the second of said elements in a different second memory block (Bₚ₂) using a second local address (a′₂)

The invention relates to a method and an arrangement for accessing matrix elements in a memory, in particular in a general purpose memory.

According to the invention, accessing does also mean storing, i.e. reading and writing.

Implementing a matrix in memory is usually done by assigning one memory element of width W to each matrix element. The matrix has M*N elements, where M denotes the number of columns and N the number of rows. Obviously, a memory for storing this matrix needs a size of M*N entries, each of width W. For the implementation, all rows or columns are concatenated to a single chain of matrix elements which is mapped to a range of addresses of the memory. The matrix is accessible, for example, by a relative address in relation to the beginning of the chain in the memory. Depending on whether the rows or the columns of the matrix are chained up, incrementing the address will provide row wise or column wise access, respectively. In order to access concatenated rows column wise, the relative address has to be increased by the number of columns in each step and vice versa. For example, if the rows are chained up, an element in column m, row n can be accessed using the relative address n*M+m, where m=0 . . . M−1, n=0 . . . N−1.

The control logic for such a row wise or column wise access is relatively straight-forward in case only one matrix element shall be accessed at a time. If several adjacent elements shall be read or written at the same time, there occurs a bandwidth loss for at least one access type. Assuming for example that the rows are concatenated, adjacent matrix elements within one row could be located in a single memory cell of width l*W. In this case, for row-wise access, l-elements could be read or written in parallel. For column-wise access, the elements are distributed over several memory cells and can not be accessed at the same time. This assumes a single-ported memory, which is the most area and cost efficient implementation.

It is thus an object of this invention to specify a method and an arrangement for accessing matrix elements by which it is possible to access several adjacent elements at the same time without bandwidth loss for row as well as column wise access.

The problem is solved by a method comprising the features given in claim 1 and by an arrangement comprising the features given in claim 9.

Advantageous embodiments of the invention are given in the respective dependent claims.

According to the invention, accesses to two matrix elements that are adjacent in a row or in a column of a matrix and that are each specified by a respective relative address are performed for the first of said elements in a first memory block using a first local address and for the second of said elements in a different second memory block using a second local address. In comparison to the prior art, the invention essentially performs a reordering of the matrix elements before they are written to the different memory blocks and after they have been read from these memory blocks, respectively, wherein no two adjacent matrix elements are stored in the same memory block, regardless if they are adjacent in a row or in a column. In other words, elements that are horizontally or vertically adjacent in the matrix are distributed to different memory blocks. The invention can be easily extended to a certain number of adjacent matrix elements greater than two if no adjacent matrix elements of this number are stored in the same memory block, i.e. if there is an equal number of memory blocks available. Such accesses can be granted row wise or column wise. This enables simultaneous access to several adjacent elements of a matrix without bandwidth loss. Besides, the number of bus transactions is minimised by this method. Both results lead to a reduction in power consumption of a system utilising the principle according to the invention. For example, in a system for digital video broadcasting for handheld appliances, the power consumption is reduced by minimising power-on time of burst based wireless transmission systems as well as reducing power consumption during power-on times.

In an advantageous embodiment, the number of columns and the number of rows of the matrix each are a multiple of the number of memory blocks used. Otherwise, the average bandwidth is reduced, since accesses to the matrix boundaries do not utilize the bandwidth of all memories at the same time. For example, a matrix with size 10×10 and four memories, when accessing one row or column, there will be three accesses, utilizing the memory bandwidth by 10/(4*3).

In a first possible embodiment, for each of said matrix elements said respective memory block and/or said respective local address are determined from a look-up table using said respective relative address for an index. This is a fast way for obtaining the memory blocks and/or the local addresses, but an additional memory is needed for the look-up table.

In a second possible embodiment, for each of said matrix elements said respective memory block is determined from a first sub-group of bits of the respective relative address and/or said respective local address is determined from a second sub-group of bits of the respective relative address. This is a fast way for obtaining the memory blocks and/or the local addresses, too. A lookup-table is not required and thus less memory is needed.

In a third possible embodiment, for each of said matrix elements said respective memory block and/or said respective local address are calculationally determined from said respective global linear address. This is an easy way for obtaining the memory blocks and/or the local addresses. Memory for a look-up table is not needed.

The determination can be advantageously performed by shifting or swapping bits of said respective relative address for obtaining said respective memory block and/or for obtaining said respective local address, the local addresses having a narrower address space than the relative addresses. Such bit shifting or swapping operations can be performed without time-consuming additions, subtractions, divisions and multiplications.

Preferably, a bit rotation is performed as said shifting or swapping operation. This way, only one operation is necessary to obtain a respective memory block and/or a respective local address.

The three embodiments and their enhancements mentioned above can be combined, of course. For example, if the memory blocks are assigned to relative addresses according to a repeated pattern a memory block can be determined using a small look-up table having the same size as the pattern after the relative address has been calculationally reduced to the pattern size. As one possibility, the local address is then determined from a sub-group of bits of the relative address after rotating the bits.

Preferably, a number of memory blocks is used that is a power of two. Several simplifications in determining the memory blocks and the local addresses can be used then. It is necessary to use memory blocks that are accessible simultaneously and independently from each other.

The arrangement according to the invention comprises a plurality of memory blocks and a memory controller connected to said memory blocks, wherein the memory controller, in case of accesses to two matrix elements that are adjacent in a row or in a column of a matrix and that are each specified by a respective relative address, performs a first sub-access for the first of said elements in a first memory block using a first local address and a second sub-access for the second of said elements in a different second memory block using a second local address. Depending on the parameters chosen, results from one address calculation might be used to determine other addresses. For certain accesses for example, the local addresses might be the same for each memory.

Preferably, for each of said matrix elements said memory controller determines said respective memory block and/or said respective local address with said respective relative address.

In an advantageous embodiment, the number of memory blocks, the width of the matrix and the height of the matrix are powers of two. Several simplifications in determining the memory blocks and the local addresses can be used for a fast memory access then.

Necessarily, said first memory block and said second memory block are accessible simultaneously and independently from each other.

In the following, the invention is explained in further detail with drawings.

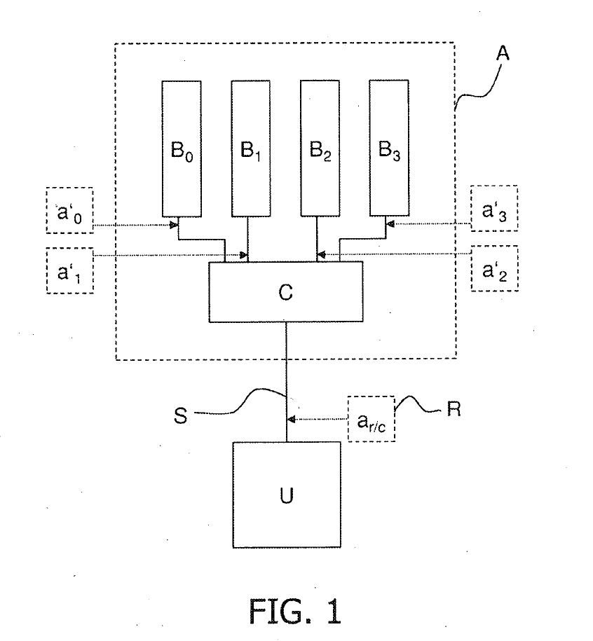

FIG. 1 shows a block diagram of an arrangement according to the invention,

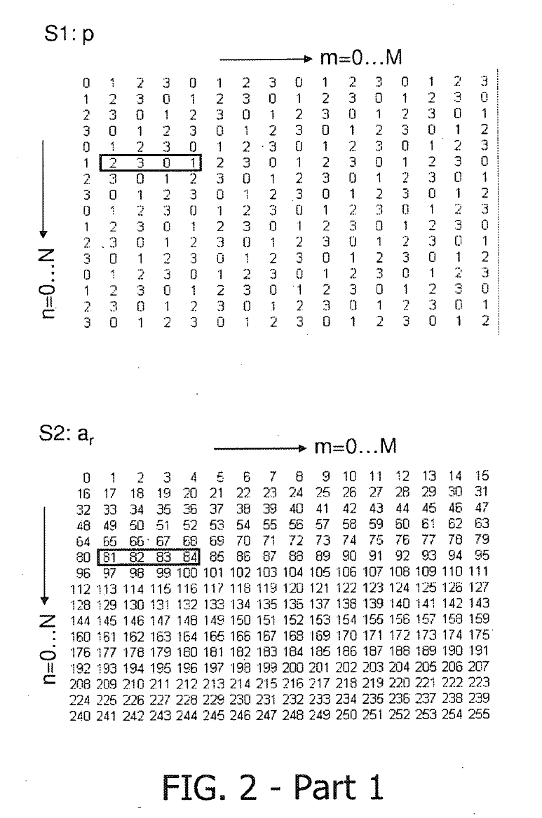

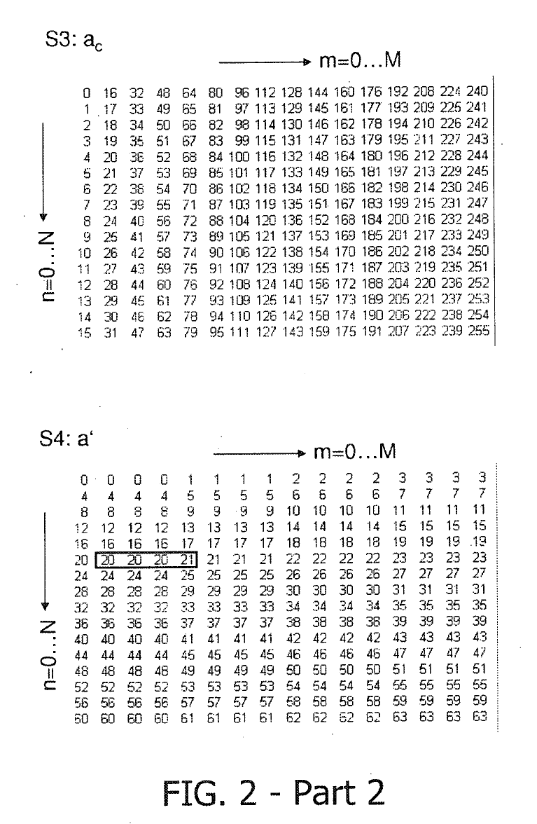

FIG. 2 shows a corresponding scheme of matrix elements, related memory blocks and local addresses and

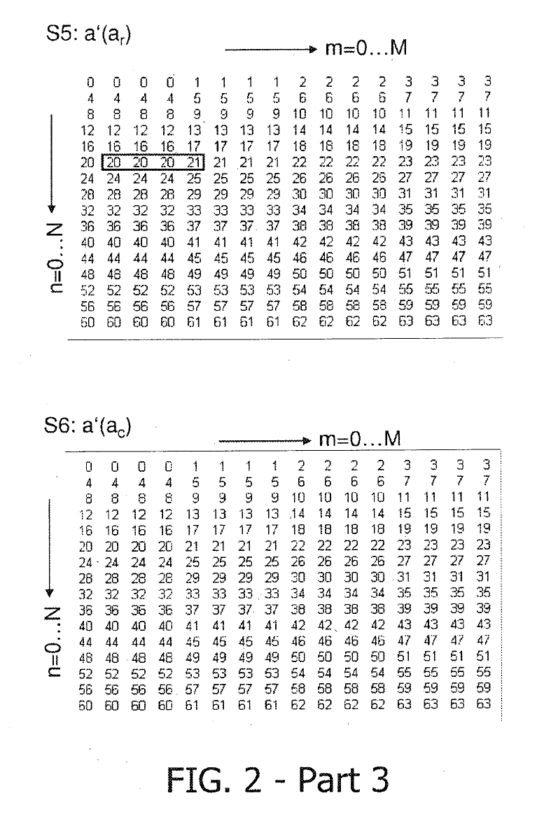

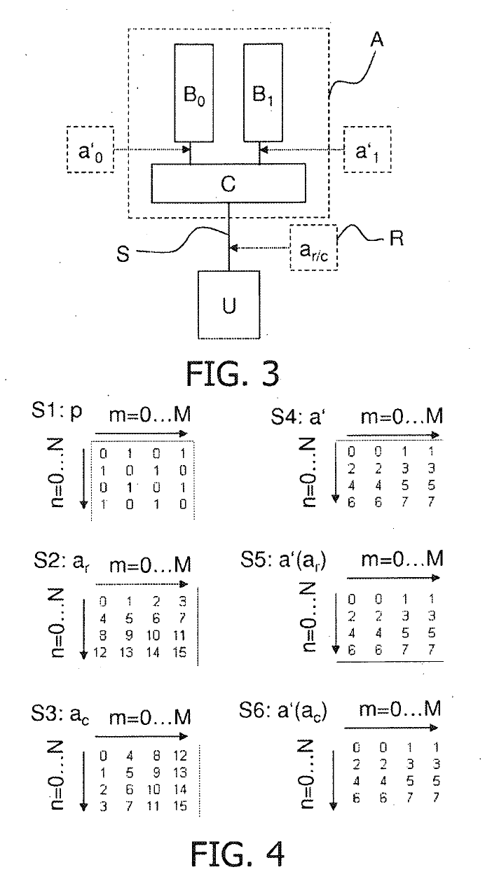

FIG. 3 shows a second scheme of matrix elements, related memory blocks and local addresses.

The arrangement A of FIG. 1 comprises four memory blocks Bₚ with P=4, numbered from p=0 to p=3 and connected to a memory controller C. The arrangement A provides 32-bit read/write capability for a matrix having (M=16)*(N=16)=256 elements of 8 bits size. The arrangement A, especially the memory controller C is connected to a central processing unit U via a system bus S.

The matrix is stored in the memory blocks Bₚ by the memory controller C in such a way that for any group of four adjacent matrix elements, regardless if they are adjacent in a row r or in a column c, each member of such a group is stored in a different one of the four memory blocks Bₚ. This enables accessing four adjacent matrix elements with one single bus request R to the memory controller C.

If a matrix element (m,n), where m=0 . . . M−1 and n=0 . . . N−1, is to be accessed by the central processing unit U the central processing unit U calculates a relative address aᵣ for a row wise access or a: for a column wise access according to the instructions it is programmed with. The central processing unit U then sends a request R to the memory controller C via the system bus S, the request R containing the type of access to the matrix, i.e. row wise or column wise in read or write mode, a relative address aᵣ for a row wise access or a_{c} for a column wise access and, in case of a write request, a value for the matrix element to be written. If the memory controller C receives such a request R it uses the relative address aᵣ or a_{c} specified in the request R to determine the number of the corresponding memory block Bₚ into which to write or from which to read the requested matrix element and the local address of the corresponding memory cell within the determined memory block Bₚ, both according to the type of access specified in the request R.

In an advantageous embodiment, the type of the access, row wise or column wise is determined by a higher address line. The matrix is then visible to the programmer of the central processing unit twice, with row access and column access starting at two different base addresses.

In general, the invention can be implemented using the following steps:
a) Organising a memory, in particular a general purpose memory, into P independently and simultaneously accessible memory blocks of depth N*M/P elements having width W. To simplify the address generation logic, the parameters N, M and P should be chosen to be powers of 2 (see for more detail FIGS. 3 and 4).
b) Arranging the relationship between matrix and memory elements, for example as follows:
   The associated memory block Bₚ for each matrix element is cycled from 0 to P−1, starting from p=0 for row r with n=0 and column c with m=0, starting at p=1 for row r with n=1 and column c with m=1 and so on. Row n=0 to n=P−1 of column m=0 are assigned to the memory blocks Bₚ with p=0 to p=P−1, respectively, the same is applied to row n=i*P to n=(i+1)*P−1, until the column is fully assigned.
   The rows of column m=1 are assigned to the memory blocks Bₚ with p=1 to p=P−1 and p=0, so the association for the second row n=1 is repeated with the same pattern, but starting at p=1 instead of p=0. These patterns are repeated throughout the matrix. This cycling applies to both row wise and column wise view. Of course, there are several other possibilities for assigning the memory buffers Bₚ to matrix elements, for example simply the other way round or even randomly. The essential condition is that no P adjacent matrix elements are stored in the same memory block Bₚ.
c) Implementing shuffle logic in the memory controller C for accessing the matrix elements. This can be done, for example, by means of a look-up table, by rotating the elements during a row wise or column wise access, or by calculating the number p of the respective memory block Bₚ and the respective local address a′ otherwise.

Because no P adjacent matrix elements are stored in the same memory block Bₚ and because all of the memory blocks Bₚ can be simultaneously accessed by the memory controller C, the memory controller C will provide access to the rows and columns of the matrix without any loss in bandwidth. The number of bus transactions on the arrangement A is minimised.

In the example of FIG. 1, any 4 horizontally or vertically adjacent matrix elements can be simultaneously accessed by one single 32-bit bus request R to the arrangement A. If, for example, four horizontally adjacent matrix elements having relative addresses:

aᵣ₁=81, aᵣ₂=aᵣ₁+1=82, aᵣ₃=aᵣ₁+2=83, aᵣ₄=aᵣ₁+3=84

are row wise requested by the central processing unit U the memory controller C determines the related first, second, third an fourth memory blocks Bₚ₁, Bₚ₂, Bₚ₃, Bₚ₄ and the related first, second, third and fourth local addresses a′₁, a′₂, a′₃, a′₄ from the respective relative addresses aᵣ₁, aᵣ₂, aᵣ₃, aᵣ₄, resulting in p=2, 3, 0, 1 and a′=20, 20, 20, 21, respectively.

If the arrangement A is used in a burst based wireless transmission system, this leads to a reduction in power consumption by minimising power-on time of as well as reducing power consumption during power-on times.

FIG. 2 illustrates the schema for the example of M=16, N==16, P=4 as described above. It can be easily adapted to numbers like M=256 and N=1024 as used in digital video broadcasting for handheld appliances. The elements of row n=0, 4, 8 . . . are associated with memory blocks Bₚ with p=0, 1, 2, 3, 0, 1, 2, 3 . . . . The elements of rows n=1, 5, 9 . . . are associated with memory blocks Bₚ with p=1, 2, 3, 0, 1, 2, 3, 0 . . . , the elements of rows n=2, 6, 10 . . . are associated with memory blocks Bₚ with p=2, 3, 0, 1, 2, 3, 0, 1 . . . . The association of row and column elements changes with each row and column, periodically every P columns and rows.

Section S1 shows which element of the matrix is stored in which memory block Bₚ.

Section S2 denotes the relative addresses aᵣ that are specified by a processor accessing the matrix row wise.

Section S3 shows the relative addresses a_{c} that are specified by the processor accessing the matrix column wise.

Section S4 illustrates the local addresses a′ that are used for selecting the matrix element within the corresponding memory block Bₚ. Obviously, no two matrix elements have both the same memory block Bₚ and the same address a′ associated at the same time. The first P elements of row 0 are accessed via a local address a′=0, the next P elements via a local address a′=1. The first P elements of row 1 are accessed using a local address a′=P=4. The same rules apply for both row wise and column wise access, of course.

Section S5 is equal to section S4, but the local addresses a′ arc determined from relative addresses aᵣ according to section S2 by dividing the relative addresses aᵣ by P:

a′=aᵣ DIV P.

Thus, this division is the operation that has to be performed on the specified relative address aᵣ given to the memory controller C to create the local address a′ in the related memory buffer B. The division can be replaced by a corresponding bit shifting operation as P is a power of 2 in this example: a′=aᵣ SHR 2. So the local address a′ is determined from a group of the upper six bits of aᵣ in row wise access mode.

Section S6 is equal to sections S4 and S5, of course, but is calculated from the relative addresses a_{c} of section S3 for column wise access. For example, the element having m=7, n=6 is specified by the relative address

a_{c}=7*16+6=11

in column wise access mode. The local address a′ is determined then from:

a′=(a_{c} SHL 2) OR (a_{c} SHR 6),

of course narrowed to the address space of the memory blocks Bₚ, i.e.

a′=((a_{c} SHL 2) OR (a_{c} SHR 6)) AND 63.

This combination of shifting operations can be expressed as a single rotation operation: a′=a_{c} ROTL 2 and a′=(a_{c} ROTL 2) AND 63, respectively. The rotation has to be carried out using the bit width of the relative address space, i.e. eight bits in this example.

For both row and column access the address translation can be performed with high speed. It is worth noting that no addition or multiplication is necessary to determine the local address a′, thus avoiding carry-chains and therefore keeping the critical paths short. This is valid as long as M, N and P are powers of two.

In this example, the first elements of row n=0, 4, 8 are located in memory block B₀, whereas the first elements of row n=1, 5, 9 are located in memory block B₁. Therefore, the P inputs and outputs of the memory blocks Bₚ have to be rotated according to the relative address aᵣ or a_{c}, respectively, for creating the input and output data of the memory controller C. For example, the number p of the respective memory block Bₚ can be calculationally determined by: p=((a_{r,c} MOD P)+(a_{r,c} DIV P)) followed by MOD P if applicable. This rule applies both for row wise and for column wise access requests R. As in this example P is a power of 2, this calculation can be performed using fast bit operations:

p=((a_{r,c} AND 3)+(a_{r,c} SHR 2)) [AND 3 if applicable]. The rule implies reduction of the relative address to the smallest repeating pattern of memory blocks Bₚ within section S1. Of course, instead of such a rule a look-up table could be used for determining the number p of the respective memory block Bₚ. Such a look-up table can be as small as the smallest repeating pattern if the relative address is reduced to it first.

FIGS. 3 and 4 show a arrangement A simplified in comparison to that of FIG. 1 and the schema related thereto, respectively. The arrangement A comprises two memory blocks Bₚ with P=2, numbered from p=0 to p=1 and connected to a memory controller C. Both memory blocks Bₚ are accessible independently and simultaneously. The arrangement A provides 32-bit read/write capability for a matrix having (M=4)*(N=4)=16 elements of 8 bits size. The arrangement A, especially the memory controller C is connected to a central processing unit U via a system bus S in the same way as in FIG. 1. It serves for row wise and/or column wise access requests R as proposed by the invention.

The numbers p=0, p=1 of the memory blocks Bₚ assigned to the matrix elements are alternating in all rows and all columns. No two matrix elements adjacent in a row or in a column are therefore stored in the same memory block Bₚ. Both memory blocks Bₚ can be simultaneously accessed by the memory controller C. The memory controller C will provide access to the rows and columns of the matrix without any loss in bandwidth. The number of bus transactions on the arrangement A is minimised.

For a row wise access, the local addresses a′ can be determined from a respective sub-group of bits of the relative addresses aᵣ according to section S2 by:

a′=aᵣ SHR 1.

For column wise access mode, the local address a′ can determined from a respective sub-group of bits of the relative addresses aᵣ according to section S2 by:

a′=(a_{c} SHL 1) OR (a_{c} SHR 3),

This combination of shifting operations can be expressed as a single rotation operation in a 4-bits address space: a′=a_{c} ROTL 1.

The number p of the respective memory block B_{P} can be determined for row wise and for column wise access requests R by:

p=((a_{r/c} AND 1)+(a_{r/c} SHR 1))

All calculations and bit operations are restricted to the 3-bits address space of the memory blocks Bₚ.

### LIST OF REFERENCE NUMERALS

A Arrangement
aᵣ Relative address for row wise access
a_{c} Relative address for column wise access
a′ Local address
Bₚ Memory blocks
C Memory controller
M Number of columns
m Column
N Number of rows
n Row
P Number of memory blocks
p Number of memory block
R Request
S System bus
U Central processing unit

1. A method for accessing matrix elements, wherein accesses to two matrix elements that are adjacent in a row or in a column of a matrix and that are each specified by a respective relative address (aᵣ, a_{c}) are performed for the first of said elements in a first memory block (Bₚ₁) using a first local address (a′₁) and for the second of said elements in a different second memory block (Bₚ₂) using a second local address (a′₂).

2. The method according to claim 1, wherein for each of said matrix elements said respective memory block (Bₚ) and/or said respective local address (a′) are determined from a look-up table using said respective relative address (aᵣ, a_{c}) for an index.

3. The method according to claim 1, wherein for each of said matrix elements said respective memory block (Bₚ) is determined from a first sub-group of bits of the respective relative address (aᵣ, a_{c}) and/or said respective local address (a′) is determined from a second sub-group of bits of the respective relative address (aᵣ, a_{c}).

4. The method according to claim 1, wherein for each of said matrix elements said respective memory block (Bₚ) and/or said respective local address (a′) are calculationally determined from said respective relative address (aᵣ, a_{c}).

5. The method according to claim 3 or 4, wherein bits of said respective relative address (aᵣ, a_{c}) are shifted and/or swapped for obtaining said respective memory block (Bₚ) and/or for obtaining said respective local address (a′), the local addresses (a′) having a narrower address space than the relative addresses (aᵣ, a_{c}).

6. The method according to claim 5, wherein a bit rotation is performed as said swapping operation.

7. The method according to one of the preceding claims, wherein a number (P) of memory blocks (Bₚ) is used that is a power of two.

8. The method according to one of the preceding claims, wherein memory blocks (Bₚ) are used that are accessible simultaneously and independently from each other.

9. An arrangement (A) for accessing matrix elements, comprising a plurality of memory blocks (Bₚ) and a memory controller (C) connected to said memory blocks (Bₚ), wherein the memory controller (C), in case of accesses to two matrix elements that are adjacent in a row or in a column of a matrix and that are each specified by a respective relative address (aᵣ, a_{c}), performs a first sub-access for the first of said elements in a first memory block (Bₚ₁) using a first local address (a′₁) and a second sub-access for the second of said elements in a different second memory block (Bₚ₂) using a second local address (a′₂).

10. The arrangement (A) according to claim 9, wherein for each of said matrix elements said memory controller determines said respective memory block (Bₚ) and/or said respective local address (a′) with said respective relative address (aᵣ, a_{c}).

11. The arrangement (A) according to claim 9 or 10, wherein the number (P) of memory blocks (Bₚ), the width (M) of the matrix and the height (N) of the matrix are powers of two.

12. The arrangement (A) according to one of the claims 9 to 11, wherein said first memory block (Bₚ₁) and said second memory block (Bₚ₂) are accessible simultaneously and independently from each other.
